(19) United States
(12) Patent Application Publication
(10) Pub. No.: US 2016/0111063 A1
(43) Pub. Date: Apr. 21, 2016

(54) SYSTEM AND METHOD FOR OPTIMIZING DYNAMIC RANGE COMPRESSION IMAGE PROCESSING COLOR

(71) Applicant: Trusight, Inc., Cupertino, CA (US)

(72) Inventor: Kevin P. Grundy, Fremont, CA (US)

(21) Appl. No.: 14/918,098

(22) Filed: Oct. 20, 2015

Related U.S. Application Data
(60) Provisional application No. 62/066,166, filed on Oct. 20, 2014.

(51) Int. Cl. G09G 5/02

(52) U.S. Cl. CPC G09G 5/02; G09G 2340/06

(57) ABSTRACT

A method for adjusting chrominance of one or more digital images comprising: receiving a digital representation of an image; adjusting a chrominance of said image using a first coefficient for image light luminance dynamic range compression, a second coefficient for image dark luminance dynamic range compression, and a third coefficient for image balance between light and dark compression.

### RELATED APPLICATIONS

This application claims priority from U.S. provisional application No. 62/066,166, filed on Oct. 20, 2014 which is all incorporated by reference herein in its entirety.

### FIELD OF THE INVENTION

The present invention relates to the field of image processing.

### BACKGROUND OF THE INVENTION

The use of only luminance to enhance or adjust an image for better viewing has existed for many years. In particular, a dynamic range compression (DRC) image processing method taught by Moredechai Sheffer in U.S. Pat. No. 6,091,164 entitled “Method for Automated High Speed Improvement of Digital Color Images” issued on May 31, 2005 and provides for image enhancement exclusively based upon luminance and not chrominance. There is an advantage in only adjusting luminance. Foremost, for film makers wanting to ensure an accurate representation of their craft, avoiding chrominance changes at least satisfies the technical argument that color is not shifting. In addition, avoiding the computations associated with chrominance adjustment provides for wide spread deployment of image processing applications across a wide set of devices.

While image recording purests may continue to demand that an image's color is never adjusted, there are others who argue that adjusting color in an intelligent manner is not only reasonable but warranted as luminance levels are shifted.

Applying a dynamic range adjustment to chrominance in addition to luminance provides a method to enhance or mute an image's color appearance as the luminance is adjusted.

Embodiments herein make use of techniques for adjusting the chrominance of an image as a function of the luminance adjustment. Sheffer teaches a method of image luminance processing utilizing light and dark computations. The aggressiveness of both the light and dark processing are controlled by fixed coefficients, K and X. These X and K settings affect how the processing improves not only the intelligibility of the resulting image but also the overall energy required to present a processed image on different display devices. Furthermore, incorporated herein by reference is U.S. patent application Ser. No. 13/932,231 to Kevin P. Grundy, filed on Jul. 1, 2013 entitled “System and Method for Automatic Presets in Dynamic Range Compression Image Processing.”

The method taught by Sheffer for improvement of color images is designed to provide image enhancement without color adjustment. FIG. 1 is a diagram for a DRC processor as taught by Sheffer. A digital image is supplied 10 and is normalized 20 before being introduced to separate dynamic range compression processors 12, 13 for luminance. A Balance Filter 14 is used to combine the output of the luminance compression processors 21, 22. A final image 25, 26, 27 is produced by a Color Filter 15 which utilizes data 23 from the Balance Filter 14, the normalized input data 20 and the original color components 17, 18, 19. Clearly it is seen that the color of the original image is preserved.

### SUMMARY OF THE INVENTION

A method for adjusting chrominance of one or more digital images comprising: receiving a digital representation of an image; adjusting a chrominance of said image using a first coefficient for image light luminance dynamic range compression, a second coefficient for image dark luminance dynamic range compression, and a third coefficient for image balance between light and dark compression.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram of a DRC image processing system in conventional systems.

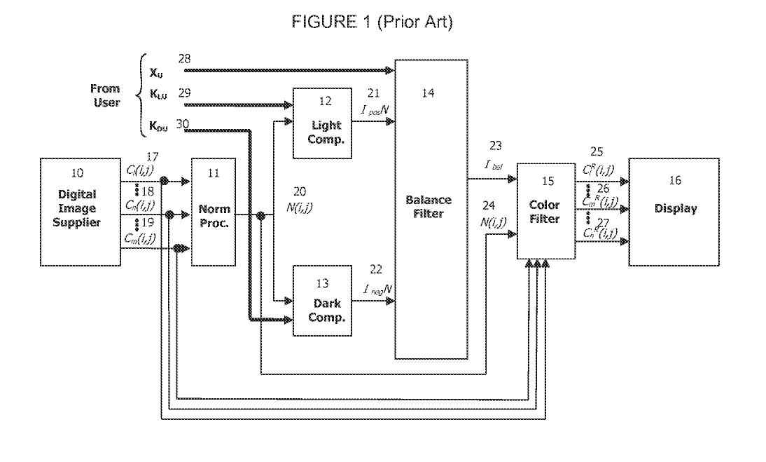

FIG. 2 is a block diagram of embodiments showing the addition of color processing.

FIG. 3 is a subset block diagram of FIG. 2 showing example color compensation and color component adjustment algorithms in accordance with embodiments.

The figures depict various embodiments for purposes of illustration only. One skilled in the art will readily recognize from the following discussion that alternative embodiments of the structures and methods illustrated herein may be employed without departing from the principles of the invention described herein.

### DETAILED DESCRIPTION OF THE INVENTION

An embodiment of the present invention is now described with reference to the figures where like reference numbers indicate identical or functionally similar elements.

In the following description and in the accompanying drawings, specific terminology and drawing symbols are set forth to provide a thorough understanding of the present invention. In some instances, the terminology and symbols may imply specific details that are not required to practice the invention. For example, a processing block may either be implemented in software or hardware. Digital representations of numerical quantities are not limited to specific number of bit accuracies. Computations required to implement the invention are not limited to fixed or floating point or any combination thereof. In the following description and block diagrams, reference is made to color components Cⱼ, Cₙ, Cₘ. Representations of color spaces are not limited to three components. Representations of color space using luma and chroma are ubiquitous and can be used herein. One common representation of images utilizes separate luminance (Y) and chroma (U & V). A Display 16 is any device capable of rendering an image for a person to view. Displays include, but are not limited to computers, televisions, smart phone, projectors and book readers.

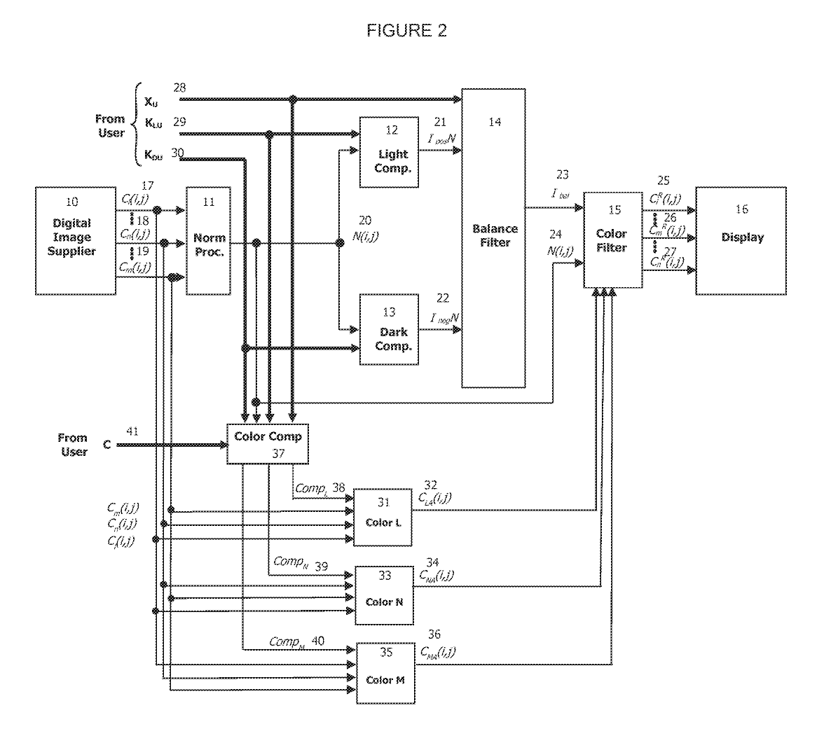

FIG. 2 illustrates an embodiment of the invention wherein a Color Comp 37 processor is added to a DRC image processing system to provide for automatic and manual calculation of color adjustments. Inputs X_{U} 28, K_{LU}, 29 and K_{DU} 30 control the Light Comp 12 and Dark Comp 13 blocks and also feed the Color Comp 37 block. The outputs of the Color Comp 37 block, Comp_{L} 38, Comp_{N} 39, Comp_{M} 40, each respectively control the individual image data components Cₗ(i,j) 17, Cₙ(i,j) 18, Cₘ(i,j) 19. The Color Comp 37 processor provides for the calculation of compensation coefficients Comp_{L} 38, Comp_{N} 39, Comp_{M} 40 from the inputs X_{U} 28, K_{LU}, 29, K_{DU} 30, N(i,j) and C 41. In one embodiment of the invention, the compensation coefficients are derived from linear relationships from the inputs. In another embodiment, the compensation coefficients are derived from non-linear relationships from the inputs. In another embodiment, the compensation coefficients are derived from a table. The compensation coefficients Comp_{L} 38, Comp_{N} 39, Comp_{M} 40 feed respectively the individual color Component Adjustment blocks Color L 31, Color N 33, Color M 35. These color component adjustments blocks modify the incoming image data components Cₗ(i,j) 17, Cₙ(i,j) 18, Cₘ(i,j) 19. The modification of the image data color components Cₗ(i,j) 17, Cₙ(i,j) 18, Cₘ(i,j) 19 in one embodiment is linear. In another embodiment, the modification is non-linear.

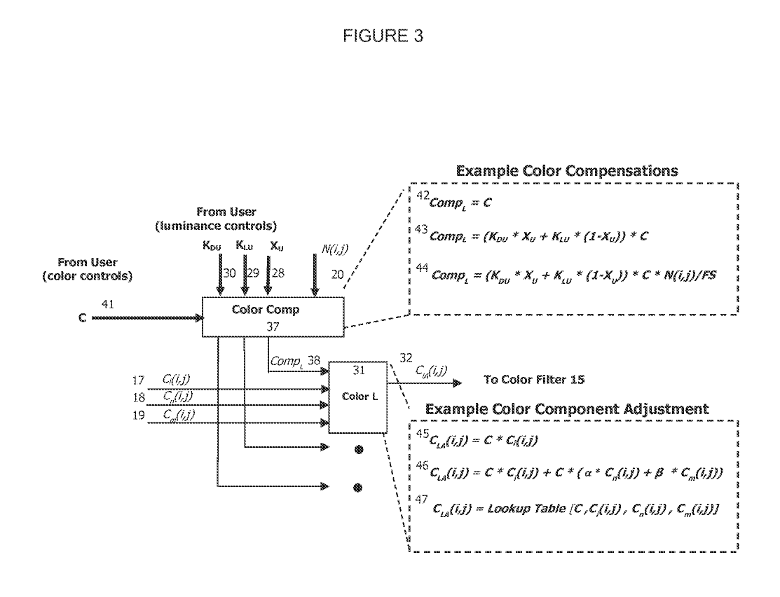

FIG. 3 further elucidates various useful functions of the Color Comp 37 block and the Color Component Adjustment blocks 31 33 35. Only the Color L Color Component Adjustment block 31 is shown. Equation 42, Comp_{L}=C, is a simple scaling approach to adjusting color components. In this particular case the color of each component is scaled, either up or down, regardless of the luminance control inputs X_{U} 28, K_{LU}, 29, K_{DU} 30. While this is a simple case it is also reflective of prior art color adjustment techniques (i.e. hue). Equation 43, Comp_{L}−(K_{DU}*X_{U}+K_{LU} *(1−X_{U}))*C is an embodiment wherein the amount of luminance compression results in the computation of an overall color compensation coefficient, Comp_{L} 38, which is linearly associated with the type and amount of luminance dynamic range a user is requesting. Equation 44 takes this control one step further by also including, as a specific pixel input control, the actual modified pixel luminance value N(i,j), Comp_{L}−(K_{DU}*X_{U}+K_{LU}*(1−X_{U}))*C*N(i,j)/FS. So, instead of a global color compensation applied as with equations 42 and 43, equation 43 allows for color adjustment on a pixel-by-pixel basis. In one embodiment Comp_{N} 39 and Comp_{M} 40 are calculated identically with Comp_{L} 38. In another embodiment, Comp_{N} 39 and Comp_{M} 40 are calculated independently and different from others.

For each color component Cl(i,j) 17, Cn(i,j) 18 , Cm(i,j) 18, there is a corresponding color component adjustment block Color L 31, Color N 33, Color M 35 which provides a method for the independently adjusting each color component from the outputs of the Color Comp 37 block. The color component adjustment blocks are in place to adjust the chrominance of specific pixel color components. The algorithms used for achieving this may be, but is not limited to, linear, non-linear equations or by lookup tables. Still referring to FIG. 3 but focusing on one of the color component adjustments blocks Color L 31, three equations 45, 46, 47 are presented. Equation 45, C_{LA}(i,j)=C*Cₗ(i,j), is a simple method to apply the computed Comp_{L} 38 color compensation from the Color Comp 37 block to each incoming color component and generating a corresponding adjusted output value. However, there are applications which might require further adjustment depending upon what the other color components Cn(i,j) 18, Cm(i,j) 18 value are. Equation 46, C_{LA}(i,j)=C*Cₗ(i,j)+C*(α*Cₙ(i,j)+β*Cₘ(i,j)) provides a method for adjusting the results based upon the values of the other colors. The coefficients α and β specify the magnitude of the influence the other color components contribute. Another embodiment allowing for cross coupling of color components in a computing a new color value is to use a lookup table. Equation 47, C_{LA}(i,j)=Lookup Table [C, Cₗ(i,j), Cₙ(i,j),Cₘ(i,j)] wherein the four parameters in the braces are indices into a precomputed table of output values for C_{LA}(i,j) 32. Each of the calculations described in the foregoing do not necessarily account for desired scaling or ranges of coefficients in specific applications. However they do illustrate various embodiments of calculating color adjustments derived from dynamic luminance compression settings.

Reference in the specification to “one embodiment” or to “an embodiment” means that a particular feature, structure, or characteristic described in connection with the embodiments is included in at least one embodiment. The appearances of the phrase “in one embodiment” or “an embodiment” in various places in the specification are not necessarily all referring to the same embodiment.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations or transformation of physical quantities or representations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “determining” or the like, refer to the action and processes of a computer system, or similar electronic computing device (such as a specific computing machine), that manipulates and transforms data represented as physical (electronic) quantities within the computer system memories or registers or other such information storage, transmission or display devices.

Certain aspects of the embodiments include process steps and instructions described herein in the form of an algorithm. It should be noted that the process steps and instructions of the embodiments can be embodied in software, firmware or hardware, and when embodied in software, could be downloaded to reside on and be operated from different platforms used by a variety of operating systems. The embodiments can also be in a computer program product which can be executed on a computing system.

The embodiments also relate to an apparatus for performing the operations herein. This apparatus may be specially constructed for the purposes, e.g., a specific computer, or it may comprise a computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Memory can include any of the above and/or other devices that can store information/data/programs and can be transient or non-transient medium, where a non-transient or non-transitory medium can include memory/storage that stores information for more than a minimal duration. Furthermore, the computers referred to in the specification may include a single processor or may be architectures employing multiple processor designs for increased computing capability.

The algorithms and displays presented herein are not inherently related to any particular computer or other apparatus. Various systems may also be used with programs in accordance with the teachings herein, or it may prove convenient to construct more specialized apparatus to perform the method steps. The structure for a variety of these systems will appear from the description herein. In addition, the embodiments are not described with reference to any particular programming language. It will be appreciated that a variety of programming languages may be used to implement the teachings of the embodiments as described herein, and any references herein to specific languages are provided for disclosure of enablement and best mode.

In addition, the language used in the specification has been principally selected for readability and instructional purposes, and may not have been selected to delineate or circumscribe the inventive subject matter. Accordingly, the disclosure of the embodiments is intended to be illustrative, but not limiting, of the scope of the embodiments, which is set forth in the claims.

While particular embodiments and applications have been illustrated and described herein, it is to be understood that the embodiments are not limited to the precise construction and components disclosed herein and that various modifications, changes, and variations may be made in the arrangement, operation, and details of the methods and apparatuses of the embodiments without departing from the spirit and scope of the embodiments as defined in the appended claims.

What is claimed is:

1. A method for adjusting chrominance of one or more digital images comprising:
receiving a digital representation of an image;
adjusting a chrominance of said image using a first coefficient for image light luminance dynamic range compression, a second coefficient for image dark luminance dynamic range compression, and a third coefficient for image balance between light and dark compression.

2. The method of claim 1, further comprising the step of receiving said first, second and third coefficients from a user.
